(19) United States
(12) Patent Application Publication
(10) Pub. No.: US 2026/0104348 A1
(43) Pub. Date: Apr. 16, 2026

(54) MEASURING DEVICE AND METHOD FOR QUANTITATIVE CHEMICAL ANALYSIS

(71) Applicant: SAFECHEM Europe GmbH, Düsseldorf (DE)

(72) Inventors: Sebastian HILL, Erkelenz (DE); Dieter LUKOWSKI, Geldern (DE)

(73) Assignee: SAFECHEM Europe GmbH, Düsseldorf (DE)

(21) Appl. No.: 19/314,273

(22) Filed: Aug. 29, 2025

(30) Foreign Application Priority Data
Oct. 11, 2024 (EP) 24206237.0

(51) Int. Cl. G01N 21/03; G01N 21/25

(52) U.S. Cl. CPC G01N 21/03; G01N 21/251; G01N 2021/0325

(57) ABSTRACT

A measuring device for quantitative chemical analysis uses a conveying unit connected to a sample container, a measuring container, and at least one reagent container via a multiple valve. A reagent is conveyed by the conveying unit from the reagent container into the measuring container, which contains a sample. A sensor that detects a transition point is attached to the measuring container. The device can also be connected to a waste container. One method of using this device involves drawing the sample, adding it to the measuring container, and measuring the transition point.

### CROSS REFERENCE TO RELATED APPLICATIONS

Applicant claims priority under 35 U.S.C. §119 of European Application No. 24206237.0 filed October 11, 2024, the disclosure of which is incorporated by reference.

### BACKGROUND OF THE INVENTION

### FIELD OF THE INVENTION

The present invention relates to a measuring device for quantitative chemical analysis, comprising a conveying unit which is materially connected to at least one sample container for receiving a sample, at least one reagent container with a reagent, and a measuring container, wherein the measuring container is assigned at least one sensor for detecting a transition point of a chemical reaction between the sample and the reagent, which sensor is data-connected to an evaluation unit for evaluating the measurement signals of the at least one sensor, wherein the conveying unit is assigned an intermediate storage device, and it can be alternately connected to the sample container, the measuring container, and the at least one reagent container via a multiple valve; the invention also relates to a corresponding method.

### DESCRIPTION OF THE RELATED ART

Such a device is known, for example, from CN 113218742 A. Furthermore, reference is made to DE 9000950 U1, DE 102019 134611 A1, CN 113514601 A, and US 6096274 A.

In addition, such a device and such a method are already known from document EP 3901621 B1. It is proposed there to supply a measuring chamber via a large number of supply lines so that the measurement of the sample can be automated and performed as simply as possible. Both a sample and reagents as well as indicators can be introduced into the measuring chamber via appropriate supply lines and mixed there using a stirring device. Using a sensor, the sample can be optically monitored, and optically detectable changes can be recorded via the sensor. In this way, measurements can be carried out and repeated automatically.

Specifically, this is a sample of a solvent-based cleaning bath, the condition and suitability of which for further use is to be tested and ensured. Samples are taken automatically at regular intervals, tested, and, if tested positive, rinsed into a waste container. As long as the cleaning solution meets the requirements, it can continue to be used. If the test shows that the condition of the cleaning solution deviates from the desired condition, the operator is shown a recommended course of action (corrective action) based upon the measurement result.

In the field of quantitative chemical analysis, especially of solvents, it is common to use various methods and devices to determine the concentration of substances in a sample. Known systems typically involve titrimetric methods in which a reagent solution of known concentration is added to a sample until a chemical reaction reaches a measurable endpoint. These endpoints can be detected by various indicators such as color changes or conductivity changes. Such systems often use manual methods, which can lead to increased error susceptibility and greater time expenditure.

When titrating immiscible liquids, an emulsion may form during mixing. Color changes that indicate the transition point of the titration cannot be detected without phase separation. However, phase separation is very time-consuming.

According to the well-known technology in solvent monitoring discussed above, automated chemical analysis systems are used to improve accuracy and efficiency. These systems often use pumps and valves to move and dose liquids. Despite automation, challenges remain, particularly with regard to dosing precision and the reliability of detection of transition points, but such systems should also be able to operate as simply and cost-effectively as possible.

Automated titration systems often work with sensors that are located directly in the measuring container. However, the sensors are in contact with the sample, which makes the sensors more susceptible to maintenance.

In addition, there are no previously known measuring devices in solvent monitoring that can be integrated into a cleaning system, such that the measuring process, including sampling from the system, runs completely autonomously.

### SUMMARY OF THE INVENTION

It is therefore a technical problem underlying the present invention to provide a device and a method for quantitative chemical analysis in which the transition point of a chemical reaction can be measured contactlessly. In addition, emulsions shall also be able to be analyzed directly without prior phase separation.

These objects are achieved by the features of the device according to one aspect of the invention and the coordinated method according to another aspect of the invention. Moreover, further advantageous embodiments of both the device and the method are discussed below.

A measuring device for quantitative chemical analysis is provided, comprising a conveying unit which is materially connected to at least one sample container for receiving a sample, at least one reagent container with a reagent, and a measuring container, wherein at least one sensor for detecting a transition point of a chemical reaction between the sample and the reagent is assigned to the measuring container, which sensor is data-connected to an evaluation unit for evaluating the measurement signals of the at least one sensor, wherein an intermediate storage device is assigned to the conveying unit, and it can be alternately connected to the sample container, the measuring container, and the at least one reagent container via a multiple valve, the device is according to the invention characterized in that the at least one sensor is a color sensor, preferably an RGB (red, green, blue) sensor, wherein the sample container is materially connected to the conveying unit via a measuring chamber, wherein an image sensor, in particular an RGB camera and/or a near-infrared sensor for optically testing the sample, is assigned to the measuring chamber.

The measuring device for quantitative chemical analysis comprises a conveying unit which is materially connected to a sample container, a measuring container, and a reagent container - for example, via hose lines. This connection enables the transport of samples and at least one reagent between the at least three containers involved and ensures that the chemical analysis can be carried out efficiently in the measuring container. The conveying unit is assigned an intermediate storage device so that samples or reagents can be temporarily stored. The multiple valve allows flexible control of the sample flow between the containers by opening or closing different flow paths depending upon the needs of the analysis. A sample and a reagent can be transported from the sample container or the reagent container into the measuring container by the conveying unit by first adjusting the multiple valve so that a connection is established to one of the containers concerned. The sample or reagent can first be drawn into the intermediate storage device. The contents of the intermediate storage device are then released into the measuring container. After successful addition of the reagent and sample, the transition point can be measured using at least one sensor. This sensor is data-connected to an evaluation unit that evaluates the measurement signals of the sensor. This arrangement enables precise, contactless detection of the transition point during the chemical analysis. The sensor also makes it possible to measure the content of hydrogen sulfide (H₂S) from both aqueous solution and in the gas phase.

In addition, a ventilation element can be assigned to the measuring device so that sufficient air exchange is ensured in the sense of explosion protection. The measuring device can also be integrated directly into a cleaning system, since this enables a fully automated measuring process. For this purpose, a sample can be taken directly from the cleaning system, which can be analyzed using the measuring device according to the invention.

In a specific embodiment, the conveying unit can additionally be connected to at least one waste container via the multiple valve. The additional connection of the conveying unit to a waste container via the multiple valve facilitates the disposal of excess or used liquids. This contributes to the cleanliness and efficiency of the entire analysis process, since the conveying unit is responsible not only for the precise dosing and transfer of samples and reagents, but also for the safe and controlled disposal of waste liquids. The ability to alternately connect the conveying unit to the sample container, the measuring container, the reagent container, and the waste container allows the components to be assembled first and then the contents to be suctioned out of the measuring container and transferred to the waste container. The suction and discharge of a rinsing liquid for cleaning the measuring container can also be provided in this respect.

Preferably, the at least one sensor can be a color sensor, preferably an RGB sensor. The color sensor is capable of detecting color changes that occur during the chemical reaction between the sample and the reagent. These color changes are often indicators of the reaction transition point, which is crucial for quantitative analysis. The color sensor enables precise detection of these changes and thus provides accurate measurement data that can be processed by the evaluation unit. A preferred type of color sensor is the RGB sensor, which has the ability to measure the intensities of the primary colors red, green, and blue. In addition, the data-linked communication between the color sensor and the evaluation unit enables real-time monitoring and analysis of the chemical reactions, which increases the efficiency of the analysis process. For the evaluation of the image data, the RGB colors can be transferred to the HSV (hue, saturation, value) color space, so that precise detection of the transition point is possible.

Alternatively or additionally, it can be provided that the at least one sensor be a conductivity sensor. A conductivity sensor measures the electrical conductivity of a solution, which strongly depends upon the concentration of ionic species in the solution. In the described device, the conductivity sensor enables precise and rapid detection of the transition point of the chemical reaction between the sample and the reagent. This is particularly advantageous because the transition point is often accompanied by a significant change in the conductivity of the solution, allowing for accurate and reproducible measurement.

The integration of an, if necessary, additional, conductivity sensor into the measuring device improves the sensitivity and accuracy of detection compared to other sensor types, such as optical sensors, which may be less sensitive to small changes in the chemical composition. In addition, a conductivity sensor can be used in a wide range of chemical reactions, increasing the versatility of the measuring device. The data recorded by the conductivity sensor are also forwarded to the evaluation unit, which is responsible for processing and analyzing the measurement signals and for forwarding and, if necessary, further processing the measurement results. This data-linked communication between the sensor and the evaluation unit ensures fast and efficient data processing, leading to a timely and accurate determination of the transition point.

In a sensible design, it can also be provided that the measuring container be a measuring cuvette. A measuring cuvette is a specially designed vessel, usually made of optically transparent material such as quartz or glass, and optimized for performing optical measurements, particularly in spectroscopy. The use of a measuring cuvette increases the accuracy of the measurements, because the optical properties of the cuvette enable interference-free detection of the chemical reactions. This is particularly important when the sensor is used to detect a transition point in a chemical reaction between the sample and the reagent, since the optical clarity and uniform thickness of the cuvette ensure that the light transmission and absorption properties are consistent and reproducible. In addition, the standardized shape and size of the measuring cuvette enables easy handling and integration into automated conveying units such as the syringe pump, which can be alternately connected to the sample container, the measuring container, and the reagent container via a multiple valve. The use of a measuring cuvette also facilitates cleaning and reusability of the measuring device, increasing its efficiency and cost-effectiveness. In addition, the measuring cuvette can be designed to provide specific volumes for the chemical reactions, which further improves the precision of the quantitative analysis. The integration of the measuring cuvette into the measuring device ensures that the chemical reactions take place under controlled conditions, thereby increasing the reliability and reproducibility of the measurement results.

A gear pump is a type of positive displacement pump that moves liquids by the intermeshing of gears. A membrane pump, also known as a diaphragm pump, pumps liquids or gases by the movement of a flexible diaphragm. The diaphragm divides the pump chamber into two chambers: one containing the medium to be conveyed and one driven by the movement of the diaphragm. A hose pump, on the other hand, is a type of peristaltic pump that moves liquids by compressing and relaxing a flexible hose. These forms of pumps are particularly suitable for applications where gentle pumping and high chemical resistance are required. In addition, the pump types mentioned are advantageous in that they enable precise addition of the reagent and the sample.

In a specific embodiment, the conveying unit may be a syringe pump. A syringe pump, also known as an infusion pump or dosing pump, is a precise device used for the controlled conveyance of liquids such as medications or nutrient solutions - for example, in medicine. The syringe pump comprises an intermediate storage device which is designed as a syringe and can be filled with the reagent or sample. A motorized mechanism moves the syringe plunger precisely forwards to dispense the liquid into the measuring container.

Such a syringe pump is particularly suitable for use in the measuring device according to the invention since it enables very precise addition of the reagent or sample.

According to a further embodiment, the device can provide that the syringe pump have a piston which is drivingly coupled to a motor, wherein the motor is preferably a stepper motor or a linear motor. This allows precise control of the liquid movement within the device. The piston, which is coupled to a motor, can be precisely positioned and moved by the motor control, ensuring accurate dosing and conveyance of samples and reagents. A stepper motor enables incremental movement of the piston, which ensures very fine gradation of the liquid dosing and high repeatability. This is particularly important for the present quantitative chemical analysis, where the accuracy of sample and reagent dosing is crucial for the reliability and reproducibility of the measurement results. A linear motor offers similar advantages by enabling smooth and controlled movement of the piston, resulting in stable and precise conveyance of the liquids. The combination of these features significantly improves the overall performance of the measuring device. In addition, the drive-coupled motor control enables automated and programmable control of the syringe pump, which simplifies the operation of the measuring device so that operating personnel only have to monitor the device at certain regular intervals, but do not have to operate it continuously. The ability to control the motor electronically also opens up the possibility of integration into complex control systems and remote monitoring and control of the measuring device.

The syringe pump can be connected to the multiple valve via a hose and can have a piston of which the volume is smaller than the volume of the hose, wherein the hose serves as an intermediate storage device, and the piston is drivingly coupled to a motor, preferably a stepper motor or a linear motor. Such an embodiment is advantageous in that the sample or reagent can first be drawn into a hose, thus protecting the syringe.

Furthermore, it can be provided that the measuring container and/or the sample container and/or the at least one reagent container be connected to the multiple valve of the conveying unit via hose lines. Hose lines allow for a flexible and modular connection between the various containers and the conveying unit, increasing the adaptability of the device to different sample and reagent volumes as well as to different chemical reactions. This is particularly advantageous in laboratory environments where different analyses need to be performed frequently, since the hose lines can be easily replaced or reconfigured without having to dismantle the entire device. Secondly, the hose lines help minimize the risk of cross-contamination between different samples and reagents. Since the hose lines are usually made of inert material that is chemically resistant, the purity of the samples and reagents is ensured. Thirdly, the hose lines facilitate cleaning and maintenance of the measuring device. They can be easily removed, cleaned, and either replaced or re-attached, maximizing the operating time of the device and reducing the need for frequent maintenance.

Furthermore, it can be provided that the multiple valve comprise a stator with different outlets and a rotor with at least one rotatable line. The stator serves as a fixed part of the valve and has several outlets, each of which is connected to different components of the measuring device, such as the sample container, the measuring container, and the reagent container. The rotor, on the other hand, is mounted rotatably within the stator and contains at least one line that can establish various connections between the conveying unit and the stator outlets by rotation of the rotor. The rotational position of the rotor forms a specific path from the conveying unit to one of the outlets of the multiple valve, whereby the conveying unit can be selectively connected to the sample container, the measuring container, or the at least one reagent container, as well as, if present, the waste container or a rinsing agent container and the like.

In a sensible embodiment, the sample container can be materially connected to the conveying unit via a measuring chamber, wherein an imager, in particular an RGB camera and/or a near-infrared sensor for optical testing of the sample, is assigned to the measuring chamber. The assignment of an RGB camera and/or a near-infrared sensor to the measuring chamber has the advantage that the sample can be monitored not only chemically, but also visually. This allows the detection of visual changes or anomalies in the sample that could indicate chemical reactions that might not be detected by the sensors alone. The camera can capture high-resolution images or videos of the sample, which can then be analyzed by the evaluation unit to provide additional data points that complement the chemical analysis. This visual monitoring can be particularly beneficial in complex chemical reactions where color changes, turbidity, or other visual indicators may occur that indicate the progress or outcome of the reaction. In the example mentioned at the outset, a cleaning liquid can be sorted out in a first step if it has become so turbid that a measurement is unnecessary.

By integrating the RGB camera into the measurement chamber, the measurement device becomes more versatile and powerful, since it is now capable of capturing both quantitative chemical data and qualitative visual information. This can significantly improve the reliability and accuracy of analytical results and provide the ability to monitor and analyze a wider range of chemical reactions. In addition, the camera can operate in real time, providing immediate feedback on the state of the sample and the progress of the chemical reaction. This is particularly useful in applications where time-critical decisions need to be made or where the response needs to be continuously monitored. A near-infrared sensor (NIR sensor) is an optical device that detects light in the near-infrared range of the electromagnetic spectrum. The near-infrared range is typically between 700 nm and 2,500 nm in wavelength. It can be used to measure the turbidity of the sample.

A further embodiment may provide that the sample container be materially connected to the conveying unit via a filter. The filter's primary purpose is to remove impurities and particles from the sample before they enter the conveying unit. This is especially important for ensuring the accuracy and reliability of the chemical analysis, since impurities could interfere with the chemical reaction between the sample and the reagent. The integration of the filter ensures that only purified samples enter the measuring container, which ensures the operational capability of the measuring device, because the filter protects the conveying unit from possible damage caused by particles or deposits that could impair the pump's mechanics. This extends the service life of the conveying unit and reduces the maintenance outlay. The filter can also act as a type of barrier that prevents residues from the conveying unit from flowing back into the sample container, preventing cross-contamination between different samples. This is especially important in laboratory environments, where multiple samples are analyzed sequentially. The integration of the filter into the connection between the sample container and the pumping unit thus represents a significant improvement in the measuring device by ensuring the purity of the samples, extending the service life of the pump, and increasing the accuracy and reliability of the chemical analysis.

Preferably, the reagent may comprise either an acid or a base, or silver nitrate or mercury. First, the use of acids and bases enables a wide range of chemical reactions required for various analytical procedures. Acids and bases are fundamental reagents in chemical analysis and can be used for titration, which is necessary to determine the concentration or presence of certain ions or molecules in the sample. The integration of silver nitrate as a reagent significantly expands the application possibilities of the measuring device. Silver nitrate is a specific reagent commonly used in quantitative analysis for the determination of halide ions such as chloride, bromide, and iodide. By adding silver nitrate to a sample containing halide ions, an insoluble silver halide is formed, which can be detected by the sensor in the measuring container. This detection enables precise quantitative analysis of the halide ions in the sample.

According to a further embodiment, the reagent and/or the sample may comprise an indicator, preferably a universal indicator or potassium chromate. The indicator serves as a chemical marker that shows a visible or measurable change when the tipping point of the chemical reaction is reached. This change can be detected by the sensor and forwarded to the evaluation unit. The universal indicator has the advantage of being able to display a wide range of pH values. Potassium chromate, on the other hand, can indicate specific reactions that are relevant for certain chemical analyses.

In this respect, in addition to the device as such, a method for quantitative chemical analysis is provided, wherein a sample from a sample container and a reagent from at least one reagent container are conveyed by a conveying unit into a measuring container and mixed there up to a transition point, so that an emulsion is formed, which is analyzed by at least one sensor assigned to the measuring container for detecting a transition point of a chemical reaction, wherein the at least one sensor is data-connected to an evaluation unit for evaluating the measurement signals, wherein the conveying unit is assigned an intermediate storage device, on which a multiple valve is arranged, by means of which a material connection can be established alternately between the conveying unit and the sample container, the measuring container, and the reagent container, wherein the method is characterized according to the invention in that the at least one sensor measures the color of the emulsion by a color sensor, preferably by an RGB sensor, wherein the sample container is materially connected to the conveying unit via a measuring chamber, wherein the measuring chamber is assigned an image sensor, in particular an RGB camera and/or a near-infrared sensor, which enables an optical test of the sample, wherein the method comprises the following steps:

connecting the conveying unit to the sample container,

drawing a sample from the sample container into the conveying unit,

connecting the conveying unit to the measuring container,

adding the sample via the conveying unit to the measuring container,

connecting the conveying unit to at least one reagent container,

drawing a reagent from the reagent container into the conveying unit,

connecting the conveying unit to the measuring container,

adding the reagent from the conveying unit to the measuring container, as well as

analyzing the transition point using the sensor, assigned to the measuring container, and the evaluation unit connected to the sensor.

According to one embodiment, the sample can be transported from the sample container into a measuring chamber to which an RGB camera or a near-infrared sensor is assigned for turbidity measurement. By measuring turbidity, the sample can be checked, before analysis, for impurities in the measuring container. Such a test of the sample enables greater reliability of the measurement, since a turbid sample could distort the measurement result.

The above-described invention is explained in more detail below with reference to an exemplary embodiment.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a measuring device for quantitative chemical analysis in a schematic representation;

FIG. 2 shows a first embodiment of a multiple valve which enables the connection between the syringe pump and various outlets in a schematic front view; and

FIG. 3 shows a second embodiment of a multiple valve which enables the connection between the syringe pump and various outlets in a schematic front view.

### DETAILED DESCRIPTION OF PREFERRED EMBODIMENTS

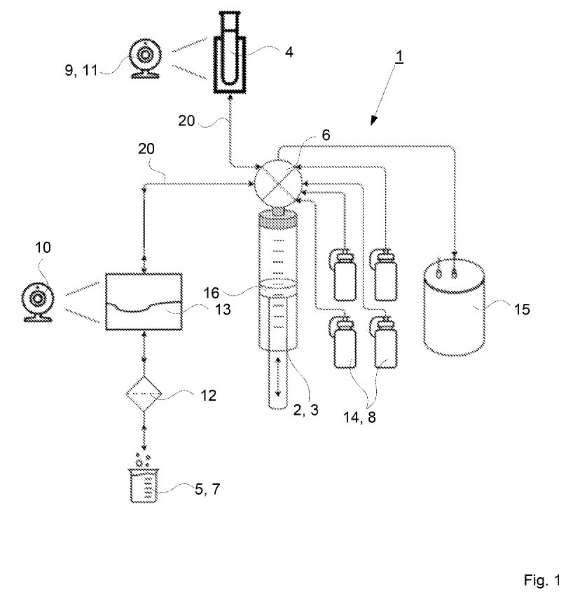

FIG. 1 shows a schematic representation of a measuring device 1 for quantitative chemical analysis. This device includes several fundamental components that are interconnected to perform precise chemical analysis.

In the center of the device, there is a syringe pump 3, which acts as a conveying unit 2. This syringe pump 3 is connected to various containers via a multiple valve 6. The multiple valve 6 enables an alternating material connection of the syringe pump 3 with a sample container 5, a measuring container 4, several reagent containers 14, and a waste container 15.

The sample container 5 contains the sample 7 to be analyzed. The sample 7 is taken from the sample container 5 by the syringe pump 3 and transferred into the measuring container 4. The measuring container 4 is a measuring cuvette which is used to carry out the chemical reaction. A sensor 11, which can be either a color sensor or a conductivity sensor, is assigned to the measuring container 4 and detects the transition point of the chemical reaction between the sample 7 and the reagent 8. The measurement signals of the sensor 11 are forwarded to an evaluation unit 9 for analysis. For the sake of simplicity, the evaluation unit 9 is shown as a unit with the sensor 11, but can also be kept in a separate unit - for example, as a process computer or as a controller.

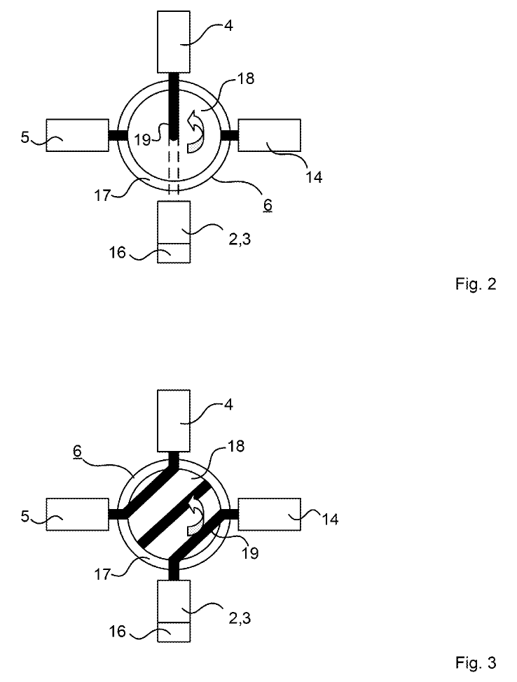

The syringe pump 3 is also connected to several reagent containers 14 containing various reagents 8. These reagents 8 may include acids, bases, or silver nitrate. The multiple valve 6 enables the syringe pump 3 to be alternately connected to the reagent containers 14 so that the reagents 8 can be transferred into the measuring container 4. The function of possible multiple valves 6 is explained in FIGS. 2 and 3.

A camera 10 is assigned to the measuring chamber 13, which is arranged between the sample container 5 and the syringe pump 3. This camera 10 enables, in a preliminary step, the optical inspection of the sample 7 during removal. A filter 12, preferably a sintered filter, is also arranged between the sample container 5 and the syringe pump 3 in order to clean the sample 7 and to retain any deposits or particles that could block or clog the measuring device 1.

The syringe pump 3 comprises a piston 16 which is drivingly coupled to a motor, preferably a stepper motor or a linear motor. This enables precise control of the conveying movements of the syringe pump 3, so that dosing of sample 7 and reagents 8 is possible via this motor.

The multiple valve 6 consists of a stator 17 with various outlets and a rotor 18 with at least one rotatable line. Depending upon the rotational position of the rotor 18, a path 19 is formed from the syringe pump 3 to one of the outlets of the multiple valve 6, thereby establishing the connection to the various containers.

The device also allows the emptying of the measuring container 4 into the waste container 15 via the syringe pump 3 after the measurement has been completed. This ensures efficient and clean handling of the samples and reagents.

In summary, FIG. 1 shows a detailed representation of the measuring device 1 for quantitative chemical analysis, wherein the various components and their connections as well as the functioning of the device are clearly shown.

FIG. 2 and FIG. 3 show schematic representations of a multiple valve 6 used in a measuring device for quantitative chemical analysis. These representations illustrate the different operating states of the valve and its connection to the various components of the device.

In FIG. 2, the multiple valve 6 is shown in a position in which the syringe pump 3 is connected to the measuring container 4. The multiple valve 6 consists of a stator 17 and a rotor 18. The stator 17 has several outlets connected to various containers 5, 4, and 14. In the state shown, the rotor 18 is positioned such that a path 19 is formed between the syringe pump 3 and the measuring container 4. This enables the dispensing of a drawn sample 7 from the cylinder of the syringe pump 3 into the measuring container 4. The measuring container 4 is connected via a hose line 20 to the multiple valve 6, which in turn is connected to the syringe pump 3. The line of the syringe pump 3 runs for the most part in the stator 17 and opens into the rotor 18 at a rotational axis thereof. As a result, the syringe pump 3 is always involved in the path 19, while, by rotating the rotor 18, the rotatable part of the line can be alternatively connected to the containers 5, 4, or 8.

In FIG. 3, the multiple valve 6 is shown in a different embodiment. Here, the rotor 18 has three paths which connect the containers 5, 4, and 14 in such a way that the syringe pump 3 as well is separated each time. This avoids cross-contamination between the different containers, since the path 19 of the multiple valve is also swapped for each container 5, 4, or 14. In the position shown, the syringe pump 3 is connected to the reagent container 14. If the rotor 18 is rotated one-eighth of a turn to the left so that the path 19 between the syringe pump 3 and the measuring container 4 is formed via the middle gear, the reagent 8 just taken up can be dosed from the syringe pump 3 into the measuring container 4. A further one-eighth turn to the left results in connection to the sample container 5.

The multiple valve 6 enables an alternating material connection of the syringe pump 3 to the sample container 5, the measuring container 4, and the reagent container 14. This is achieved by the rotational movement of the rotor 18, which, depending upon its position, forms different paths 19 between the syringe pump 3 and the respective containers.

In summary, FIG. 2 and FIG. 3 illustrate the operation of the multiple valve 6 and its connection to the various containers of the measuring device. The precise control of the conveying unit 2 by the syringe pump 3 and the multiple valve 6 enables accurate and efficient chemical analysis.

In a continuous process, the multiple valve 6 is first adjusted such that it is connected to the sample container 5. The piston 16 of the syringe pump 3 is actuated so that a quantity of the sample 7 is drawn and placed into the cylinder of the syringe pump 3. The sample 7 first passes through the filter 12 and then through the measuring chamber 13, where turbidity can be detected using the camera 10. The multiple valve 6 is now switched such that the syringe pump 3 is connected to the measuring cuvette 4.

Now, the sample 7 is transferred from the syringe pump 3 into the measuring cuvette 4 by operating the motor of the piston 16, e.g., a stepper motor, in the reverse direction and discharging the drawn sample 7 again so that it is received in the measuring cuvette 4. Subsequently, the syringe pump 3 is connected to a reagent container 14 in order to draw a reagent 8 from there and, after reconnecting the syringe pump 3 to the measuring container 4, to titrate it into the latter. An evaluation unit 9 uses a sensor 11 to monitor when a transition point is reached during the titration. The positions of the syringe pump 3 in particular are continuously recorded, so that it is possible to draw conclusions about the quantities of sample 7 and reagent 8 used. This enables automated quantitative evaluation of the sample 7. Finally, the contents of the measuring container 4 are completely drawn into the syringe pump 3, and the multiple valve 6 is rotated such that it is connected to a waste container 15 - this position is not provided in the exemplary representations of FIGS. 2 and 3 - and ejected there.

The above describes a method and a device for quantitative chemical analysis in which the transition point of a chemical reaction can be measured contactlessly. In addition, emulsions can also be analyzed directly, without prior phase separation.

Although only a few embodiments of the present invention have been shown and described, it is to be understood that many changes and modifications may be made thereunto without departing from the spirit and scope of the invention.

### LIST OF REFERENCE SIGNS

1 measuring device

2 conveying unit

3 syringe pump

4 measuring container

5 sample container

6 multiple valve

7 sample

8 reagent

9 evaluation unit

10 RGB camera

11 sensor

12 filter

13 measuring chamber

14 reagent container

15 waste container

16 piston

17 stator

18 rotor

19 path

20 hose lines

What is claimed is:

1. A measuring device for quantitative chemical analysis, comprising a conveying unit (2) which is materially connected to at least one sample container (5) for receiving a sample (7), at least one reagent container (14) with a reagent (8), and a measuring container (4), wherein the measuring container (4) is assigned at least one sensor (11) for detecting a transition point of a chemical reaction between the sample (7) and the reagent (8), wherein the sensor is data-connected to an evaluation unit for evaluating the measurement signals of the at least one sensor (11), wherein the conveying unit (2) is assigned an intermediate storage device, and the conveying unit (2) can be alternately connected to the sample container (5), the measuring container (4), and the at least one reagent container (14) via a multiple valve (6),
wherein the at least one sensor (11) is a color sensor, preferably an RGB sensor, wherein the sample container (5) is materially connected to the conveying unit (2) via a measuring chamber (13), wherein an image generator, in particular an RGB camera (10) and/or a near-infrared sensor for optically testing the sample (7), is assigned to the measuring chamber (13).

2. The measuring device according to claim 1, wherein the conveying unit (2) can additionally be connected to at least one waste container (15) via the multiple valve (6).

3. The measuring device according to claim 1, wherein the measuring container (4) is a measuring cuvette.

4. The measuring device according to claim 1, wherein the conveying unit (2) is a gear pump, a diaphragm pump, or a hose pump.

5. The measuring device according to claim 1, wherein the conveying unit (2) is a syringe pump (3).

6. The measuring device according to claim 5, wherein the syringe pump (3) has a piston (16) which serves as an intermediate storage device and is drivingly coupled to a motor, preferably a stepper motor or a linear motor.

7. The measuring device according to claim 5, wherein the syringe pump (3) is connected to the multiple valve (6) via a hose and has a piston (16) of which the volume is smaller than the volume of the hose, wherein the hose serves as an intermediate storage device and the piston (16) is drivingly coupled to a motor, preferably a stepper motor or a linear motor.

8. The measuring device according to claim 1, wherein the measuring container (4) and/or the sample container (5) and/or the at least one reagent container (14) are connected to the multiple valve (6) of the conveying unit (2) via hose lines (20).

9. The measuring device according to claim 1, wherein the multiple valve (6) comprises a stator (17) with different outlets and a rotor (18) with at least one rotatable line, wherein, depending upon the rotational position of the rotor (18), a path (19) is formed from the conveying unit (2) to an outlet of the multiple valve (6).

10. The measuring device according to claim 1, wherein the sample container (5) is materially connected to the conveying unit (2) via a filter (12).

11. The measuring device according to claim 1, wherein the reagent (8) comprises either an acid or a base, or silver nitrate or mercury.

12. The measuring device according to claim 1, wherein the reagent (8) and/or the sample (7) comprises an indicator, preferably a universal indicator or potassium chromate.

13. A method for quantitative chemical analysis, wherein a sample (7) from a sample container (5) and a reagent (8) from at least one reagent container (14) are conveyed by a conveying unit (2) into a measuring container (4) and mixed there up to a transition point, so that an emulsion is formed, which is analyzed with at least one sensor (11) assigned to the measuring container (4) for detecting a transition point of a chemical reaction, wherein the at least one sensor (11) is data-connected to an evaluation unit (9) for evaluating the measurement signals, wherein the conveying unit (2) is assigned an intermediate storage device, on which a multiple valve (6) is arranged, by means of which a material connection can be established alternately between the conveying unit (2) and the sample container (5), the measuring container (4), and the reagent container (14),
wherein the at least one sensor (11) measures the color of the emulsion by a color sensor, preferably by an RGB sensor, wherein the sample container (5) is materially connected to the conveying unit (2) via a measuring chamber (13) and an image generator is assigned to the measuring chamber (13), in particular an RGB camera (10) and/or a near-infrared sensor, which carries out an optical inspection of the sample (7), wherein the method comprises the following steps:
connecting the conveying unit (2) to the sample container (5),
drawing a sample (7) from the sample container (5) into the conveying unit (2),
connecting the conveying unit (2) to the measuring container (4),
adding the sample (7) via the conveying unit (2) to the measuring container (4),
connecting the conveying unit (2) to the at least one reagent container (14),
drawing a reagent (8) from the reagent container (14) into the conveying unit (2),
connecting the conveying unit (2) to the measuring container (4),
adding the reagent (8) from the conveying unit (2) to the measuring container (4), as well as
analyzing the transition point using the sensor (11), assigned to the measuring container (4), and the evaluation unit (9) connected to the sensor (11).

14. The method according to claim 13, wherein, in the course of removing the sample (7) from the sample container (5), a turbidity measurement is carried out with the aid of an imager, in particular an RGB camera (10) and/or a near-infrared sensor.

15. The method according to claim 13, wherein the sample (7) is cleaned via a filter (12), preferably a sintered filter, during removal from the sample container (5).

16. The method according to claim 13, wherein several reagents (8) from different reagent containers (14) are fed successively to the measuring container (4) via the conveying unit (2).

17. The method according to claim 13, wherein the measuring container (4) is emptied into a waste container (15) via the conveying unit (2) after the measurement has been completed.

18. The method according to claim 13, wherein the conveying unit (2) is a gear pump, a diaphragm pump, or a hose pump.

19. A measuring device according to claim 13, wherein the conveying unit (2) is a syringe pump (3).
